(19) United States
(12) Patent Application Publication
(10) Pub. No.: US 2019/0389473 A1
(43) Pub. Date: Dec. 26, 2019

(54) METHOD AND APPARATUS FOR ACCELEROMETER BASED TIRE NORMAL FORCE ESTIMATION

(71) Applicant: GM GLOBAL TECHNOLOGY OPERATIONS LLC, Detroit, MI (US)

(72) Inventors: Shih-ken Chen, Troy (US); Bakhtiar B. Litkouhi, Washington (US); Valery Pylypchuk, West Bloomfield (US)

(21) Appl. No.: 16/013,081

(22) Filed: Jun. 20, 2018

(51) Int. Cl. B60W 40/10; G01M 17/02; B60K 31/00; B60T 8/32; B60W 30/14; B60W 30/02

(52) U.S. Cl. CPC B60W 40/10; G01M 17/02; B60K 31/00; B60T 8/3205; B60W 2710/18; B60W 30/02; B60W 2520/00; B60W 2720/10; B60W 30/14

(57) ABSTRACT

A system and method for computationally estimating a tire normal force for use in vehicle antilock braking, adaptive cruise control, and traction and stability control by correcting measured accelerations with respect to the estimated road angles. The system and method are operative to measure an acceleration at three points on a sprung mass of the vehicle and estimate a tire normal force of a tire in response to the three acceleration measurements as an input to the vehicle controller.

### INTRODUCTION

### Field of the Invention

The present invention generally relates to a system and method for estimating tire vertical forces in a vehicle. More particular, the invention relates to a system and method for computationally estimating tire normal forces using chassis mounted accelerometers for a vehicle in real time under different configurations and road conditions for use in vehicle antilock braking, adaptive cruise control, and traction and stability control.

### Background Information

Accurate tire normal force determination is crucial for reliable performance of many vehicle control systems. Tire normal force, or vertical tire force, is a vehicle dynamic variable used by vehicle control systems such as adaptive cruise control, traction and stability control and anti-lock braking systems. Tire normal force indicates the vertical force acting downwards between the tire and the road surface. Tire normal force is a product of the vehicle weight, the surface gradient of the road and cornering force. Wheel sidewall deformation results from the tire normal force. Tire normal force is generally estimated via suspension displacement sensors, and/or simple load transfer algorithms. Often such sensors must be calibrated for sensor bias or the use of sensors having high accuracy must be utilized.

Tire normal forces can be measured at each corner, but their cost impact, calibration and maintenance are their major drawbacks to be used for production vehicles. Provided that the tire normal force calculation typically employs expensive sensors or complex algorithms to determine tire normal force in real time, it would be desirable to establish a reliable and computationally efficient algorithm, which is robust to road conditions and uncertainties without requiring expensive sensors in order to improve the performance of the chassis control and active safety systems. An ideal system would provide a reliable tire normal force estimation at each corner and be robust to the road condition for the vehicle's active safety control systems.

### SUMMARY OF THE INVENTION

In accordance with an aspect of the present invention, a vehicle control system is disclosed comprising a first accelerometer for measuring a first acceleration at a first point, a second accelerometer for measuring a second acceleration at a second point, a third accelerometer for measuring a third acceleration at a third point, a processor for estimating a tire normal force in response to the first acceleration, the second acceleration and the third acceleration, and a controller for controlling the vehicle in response to the tire normal force.

In accordance with another aspect of the present invention an apparatus is disclosed comprising a first accelerometer for measuring a first acceleration at a first location on a sprung mass of a vehicle, a second accelerometer for measuring a second acceleration at a second location on the sprung mass of the vehicle, a third accelerometer for measuring a third acceleration at a third location on the sprung mass of the vehicle, a processor for estimating a tire normal force of a tire no the vehicle in response to the first acceleration, the second acceleration and the third acceleration, and a controller for controlling the vehicle in response to the tire normal force.

In accordance with another aspect of the present invention, a method for controlling a vehicle is disclosed comprising initiating a vehicle control system, measuring a first acceleration at a first point, a second acceleration at a second point and a third acceleration at a third point, wherein the first point, the second point and the third point are locations on a sprung mass of the vehicle, estimating a vertical acceleration at a fourth point in response to the first acceleration, the second acceleration, the third acceleration, wherein the fourth point is located on an unsprung mass of the vehicle, generating a control signal in response to the vertical acceleration, and controlling the vehicle control system in response to the control signal.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a diagram showing an exemplary environment for implementing the present invention.

FIG. 2 is a schematic representation of an active vehicle dynamics control system onboard a vehicle according to an exemplary embodiment of the present invention.

FIG. 3 shows an exemplary system 300 for implementing the method and system according to the present invention.

FIG. 4 shows an exemplary three-dimensional force diagram of the sprung mass forces.

FIG. 5 shows an exemplary two dimensional force diagram of the suspension kinematics and dynamics.

FIG. 6. is a flow diagram of a method for estimating tire normal force according to an exemplary embodiment of the present invention.

The exemplifications set out herein illustrate preferred embodiments of the invention, and such exemplifications are not to be construed as limiting the scope of the invention in any manner.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

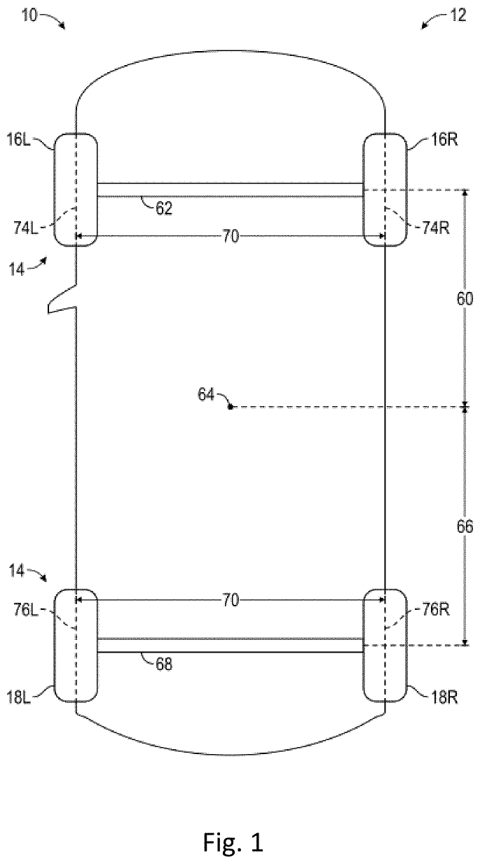

Referring to the Figures, wherein like reference numbers refer to the same or similar components throughout the several views, FIG. 1 is a schematic fragmentary plan view of a device 10 having a plurality of tires 14. The device 10 may be a vehicle 12. However, it is to be understood that the device 10 may be a robot, a farm implement, sports-related equipment or any other type of apparatus. In the embodiment shown, the plurality of tires 14 include first, second, third and fourth tires 16L, 16R, 18L, 18R, respectively. However, it is to be understood that the device 10 may include any number of tires.

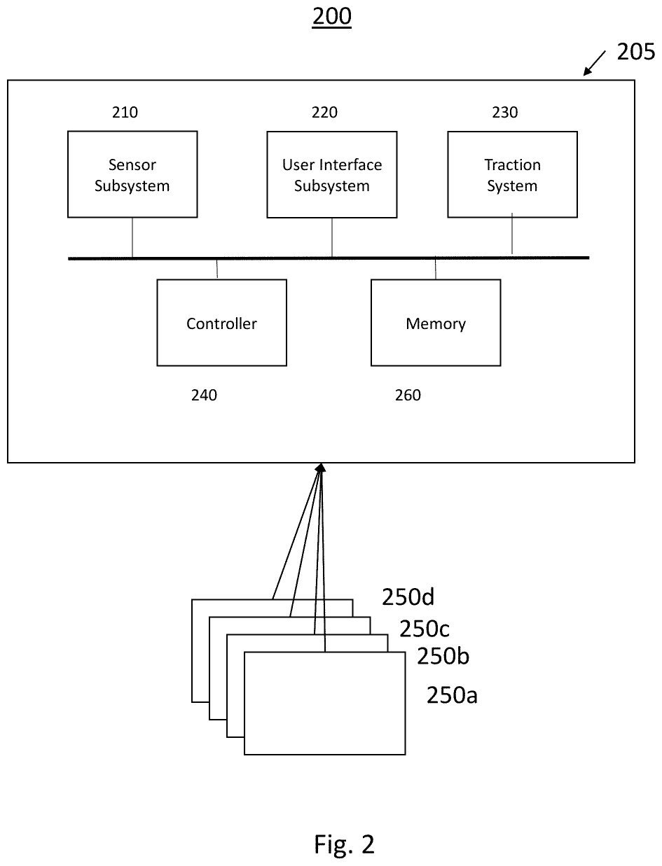

Turning now to FIG. 2, a schematic representation 200 of an exemplary embodiment of an active vehicle dynamics control system 205 onboard a vehicle is shown. Generally, a vehicle dynamics control system 205 in a vehicle may be in communication with a global positioning system and/or a plurality of sensors or systems 210 in order communicate signals to a controller 240. Vehicle dynamics control system 205 may include a controller 240 used for receiving information or signals from a number of sensors or systems which may include antilock brake system (ABS) status, a traction control system (TCS) status, positional and sensor data including GPS velocity, yaw rate, wheel speed (at each wheel), lateral acceleration, a steering angle (hand wheel position), longitudinal acceleration from a longitudinal accelerometer, pitch rate and steering angle position. Based upon these signals, controller 240 controls the vehicle dynamics system and may store the signals in an appropriate memory 260. Depending on the desired sensitivity, the type of control system and various other factors, not all of the enumerated signals may be used in a commercial application.

An exemplary vehicle includes four wheels 250a-d, each having a respective tire mounted thereto. The vehicle may be a rear-wheel drive vehicle, a front-wheel drive vehicle, an all-wheel drive vehicle, or a vehicle having a selective drive configuration. In addition, the vehicle may also have three wheels, multiple axles and more than four wheels as a matter of design choice and still benefit from the aspects of the present disclosure. Active traction control system 230, which may also be referred to as an active corner exiting control system, is an onboard vehicle-based system in that its components are located on, carried by, or integrated into the host vehicle. The active traction control system 230 may include or cooperate with at least the following components or elements, without limitation: a vehicle sensor subsystem 210; a user interface subsystem 220, and an appropriate amount of memory 260. These and other elements of the active vehicle dynamics control system 205 are coupled together in an appropriate manner to accommodate the communication of data, control commands, and signals as needed to support the operation of the system. For the sake of brevity, conventional techniques related to vehicle control systems, vehicle sensor systems, torque management, and other functional aspects of the systems (and the individual operating components of the systems) may not be described in detail herein.

Sensor subsystem 210 is suitably configured to collect real-time (and possibly non-real-time) vehicle status data during operation of vehicle. The active vehicle dynamics control system 205 can process some or all of this vehicle status data in the manner described below, and other subsystems or components might also process or utilize some or all of this vehicle status data. In certain embodiments, sensor subsystem 210 includes sensors (not shown) that collect data indicative of the yaw rate of the vehicle, the lateral acceleration of the vehicle, the velocity of the vehicle, the rotational velocity of the wheels of the vehicle, the wheel slip associated with the wheels of the vehicle, the vertical and longitudinal acceleration, the vehicle pitch, the vehicle roll rate, the wheel position relative to the body of the vehicle, or the like. The design, configuration, and operational details of such vehicle-based sensors will not be described herein because these sensors and their applications are well known to those familiar with the automotive industry.

User interface subsystem 220 is suitably configured as a human-machine interface for vehicle 205 and, in particular, for system 200. User interface subsystem 220 can be realized using one or more elements, features, devices, or components, which may be conventional in nature. For example, user interface subsystem 220 may include, without limitation, any number of: buttons; knobs; switches; levers; dials; keypads; touch screens; touch pads; or the like. To support the active vehicle dynamics control system 205, user interface subsystem 220 may include one or more features or elements configured to receive a user-selected driving condition setting that is indicative of current road conditions, the current road coefficient of friction, a current tire-to-road traction value, or the like. In certain embodiments, user interface subsystem 220 also includes one or more features or elements configured to receive a user-selected vehicle handling setting, which might be indicative of a desired suspension feel, a desired handling limit, or the like.

Corner-based vehicle state estimation is very important for reliable performance of the vehicle's traction and stability control systems. The present system utilizes a methodology to estimate the tire vertical forces that are critical for vehicle control using low cost accelerometers. The methodology is operative to use vertical accelerations at least three different points and two horizontal accelerations of the center of gravity (CG) to determine all vertical tire forces, and roll and pitch angles. More specifically, the system is operative to use the vertical accelerations of two different points of sprung mass and three accelerations components at the center of gravity to determine vertical tire forces, roll, pitch and heave states.

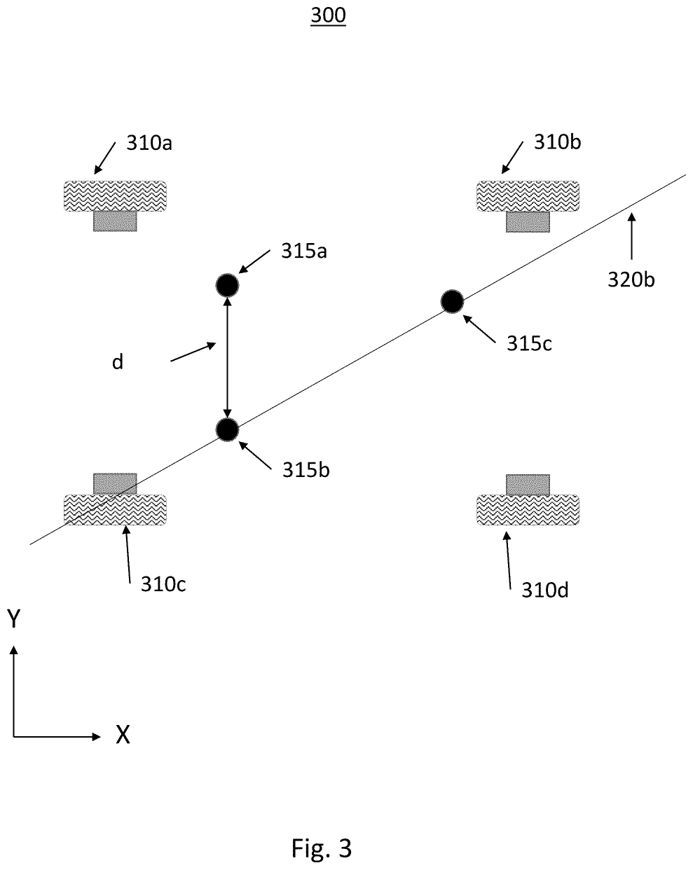

Referring to FIG. 3, the exemplary system 300 for implementing the method and system is shown. The exemplary system 300 includes a plurality of tires 310a, 310b, 310c, 310d and a plurality of accelerometers 315a, 315b, 315c. The accelerometers are distributed over the vehicle with the first accelerometer 315a located at (X₃, Y₃) and the second accelerometer 315b located at (X₂, Y₂) spaced a distance (d) apart. The third accelerometer 315c is located at (X₁, Y₁), preferable as far away from the line created by the first accelerometer 315a and the second accelerometer 315b. The distance between the first accelerometer 315a and the second accelerometer 315b is defined by the following equation.

$${Y}_{2} - {Y}_{1} = k ( {X}_{2} - {X}_{1} )$$

$$k = \frac{{Y}_{2} - {Y}_{1}}{{X}_{2} - {X}_{1}}$$

In an exemplary embodiment, for best performance, the location of the three accelerometers should not be colinear. Using vertical accelerations at three different points and two horizontal accelerations of the CG facilitates the system and algorithm to estimate all vertical tire forces and roll and pitch angles. When two out of three accelerometers are close to the sprung mass, the estimation results may become sensitive to the noise in accelerometer measurements. Briefly, this happens because, near CG, rotational components of the sprung mass are difficult to extract form vertical accelerations as the measurements from two out of three accelerometers become redundant.

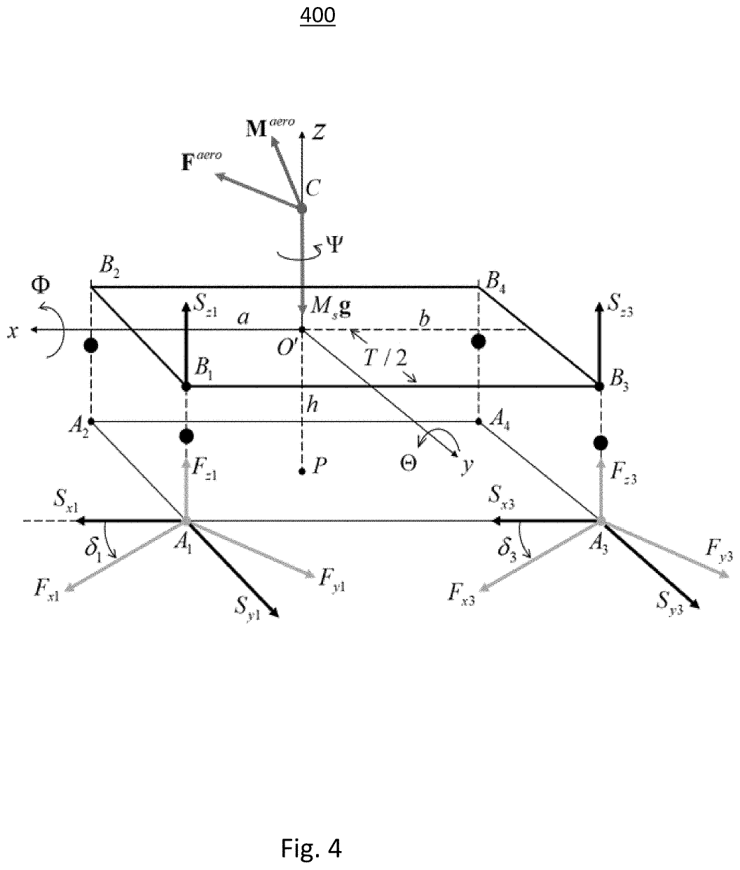

Turning now to FIG. 4, an exemplary three-dimensional force diagram 400 of the sprung mass forces are shown. The sprung masses of a vehicle are typically defined as the masses supported by the suspension components of the vehicle, such as the body, frame, engine, passengers and cargo. The unsprung masses include masses not supported by the suspension system, such as the wheels, brake rotors, axles, and axle housings. The translational sprung mass forces are formulated according to the following.

$$\{ \begin{matrix}{S}_{x 1} + {S}_{x 2} + {S}_{x 3} + {S}_{x 4} = {M}_{s} ( {a}_{x} - g Θ ) - {F}_{x}^{aero} ≡ {F}_{x} \\ {S}_{y 1} + {S}_{y 2} + {S}_{y 3} + {S}_{y 4} = {M}_{s} ( {a}_{y} + g Φ ) - {F}_{y}^{aero} ≡ {F}_{y} \\ {S}_{z 1} + {S}_{z 2} + {S}_{z 3} + {S}_{z 4} = {M}_{s} [ {a}_{z} + g ( 1 - \frac{{Φ}^{2}}{2} - \frac{{Θ}^{2}}{2} ) ] - {F}_{z}^{aero} ≡ {F}_{z}\end{matrix}$$

The sprung mass moments are determined in response to the sprung mass forces and are formulated according to the following.

$$\{ \begin{matrix}\frac{1}{2} T ( {S}_{z 1} - {S}_{z 2} + {S}_{z 3} - {S}_{z 4} ) + h ( {S}_{y 1} + {S}_{y 2} + {S}_{y 3} + {S}_{y 4} ) = {Q}_{x} \\ - a ( {S}_{z 1} + {S}_{z 2} ) + b ( {S}_{z 3} + {S}_{z 4} ) - h ( {S}_{x 1} + {S}_{x 2} + {S}_{x 3} + {S}_{x4} ) = {Q}_{y} \\ \frac{1}{2} T ( - {S}_{x 1} + {S}_{x 2} - {S}_{x 3} + {S}_{x 4} ) + a ( {S}_{y 1} + {S}_{y 2} ) - b ( {S}_{y 3} + {S}_{y 4} ) = {Q}_{z}\end{matrix}$$

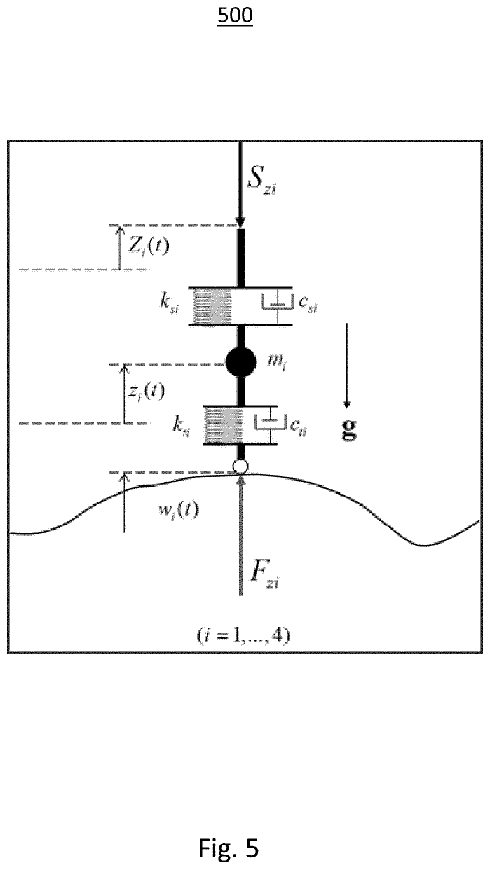

Turning now to FIG. 5, an exemplary two dimensional force diagram 500 of the suspension kinematics and dynamics are shown. The suspension kinematics and dynamics are formulated according to the following

$$\{ \begin{matrix}{Z}_{1} = {Z}_{C} - a Θ - \frac{1}{2} T Φ \\ {Z}_{2} = {Z}_{C} - a Θ - \frac{1}{2} T Φ \\ {Z}_{3} = {Z}_{C} + b Θ + \frac{1}{2} T Φ \\ {Z}_{4} = {Z}_{C} + b Θ - \frac{1}{2} T Φ\end{matrix} \{ \begin{matrix}{m}_{i} {\ddot{z}}_{i} = {m}_{i} g - {S}_{zi} + {F}_{zi} \\ {S}_{zi} = {k}_{si} ( {z}_{i} - {Z}_{i} ) + {c}_{si} ( {\dot{z}}_{i} - {\dot{Z}}_{i} ) \\ {F}_{zi} = {k}_{ti} ( {w}_{i} - {z}_{i} ) + {c}_{ti} ( {\dot{w}}_{i} - {\dot{z}}_{i} )\end{matrix}$$

It is desirable to use the Laplace space due to the specific of suspension model including vertical displacements, velocities and accelerations the wheel centers. The suspension equations involved enable the entire system uniquely solvable for four tire forces. The solutions for the individual tire forces may be determined in terms of Laplace images, where in turn, the tire forces are determined according to the following.

$$\{ \begin{matrix}{\overline{F}}_{z 1} = \frac{1}{2} \{ \frac{b {\overline{F}}_{z} - {\overline{F}}_{x} h - {\overline{Q}}_{y}}{a + b} + {m}_{f} ( {\overline{a}}_{z 1} + {\overline{a}}_{z 2} ) + \frac{2 {A}_{f} ( p ) ( \overline{{Q}_{x}} - h \overline{{F}_{y}} )}{T} \} \\ {\overline{F}}_{z 2} = \frac{1}{2} \{ \frac{b {\overline{F}}_{z} - {\overline{F}}_{x} h - {\overline{Q}}_{y}}{a + b} + {m}_{f} ( {\overline{a}}_{z 1} + {\overline{a}}_{z 2} ) - \frac{2 {A}_{f} ( p ) ( \overline{{Q}_{x}} - h \overline{{F}_{y}} )}{T} \} \\ {\overline{F}}_{z 3} = \frac{1}{2} \{ \frac{b {\overline{F}}_{z} + {\overline{F}}_{x} h + {\overline{Q}}_{y}}{a + b} + {m}_{r} ( {\overline{a}}_{z 3} + {\overline{a}}_{z 4} ) + \frac{2 {A}_{r} ( p ) ( \overline{{Q}_{x}} - h \overline{{F}_{y}} )}{T} \} \\ {\overline{F}}_{z 4} = \frac{1}{2} \{ \frac{b {\overline{F}}_{z} + {\overline{F}}_{x} h + {\overline{Q}}_{y}}{a + b} + {m}_{r} ( {\overline{a}}_{z 3} + {\overline{a}}_{z 4} ) - \frac{2 {A}_{f} ( p ) ( \overline{{Q}_{x}} - h \overline{{F}_{y}} )}{T} \}\end{matrix} \\ \{ \begin{matrix}{A}_{f} ( p ) = \frac{{pc}_{f} + {k}_{f}}{p ( {c}_{f} + {c}_{r} ) + {k}_{f} + {k}_{r}} \\ {A}_{r} ( p ) = \frac{{pc}_{r} + {k}_{r}}{p ( {c}_{f} + {c}_{r} ) + {k}_{f} + {k}_{r}}\end{matrix} \\ Where \\ {Q}_{x} = {I}_{xx} [ \frac{( {x}_{3} - {x}_{2} ) Az 1}{Δ} + \frac{( {x}_{1} - {x}_{3} ) Az 2}{Δ} + \frac{( {x}_{2} - {x}_{1} ) Az 3}{Δ} ] \\ {Q}_{y} = {I}_{yy} [ \frac{( {y}_{3} - {y}_{2} ) Az 1}{Δ} + \frac{( {y}_{1} - {y}_{3} ) Az 2}{Δ} + \frac{( {y}_{2} - {y}_{1} ) Az 3}{Δ} ] \\ {F}_{z} = {M}_{s} [ \frac{Az 1 ( {x}_{2} {y}_{3} - {x}_{3} {y}_{2} )}{Δ} + \frac{Az 2 ( {x}_{3} {y}_{1} - {x}_{1} {y}_{3} )}{Δ} + \frac{Az 3 ( {x}_{1} {y}_{2} - {x}_{2} {y}_{1} )}{Δ} ] \\ Δ = {x}_{3} ( {y}_{1} - {y}_{2} ) + {x}_{1} ( {y}_{2} - {y}_{3} ) + {x}_{2} ( {y}_{3} - {y}_{1} ) \neq 0$$

Azi—vertical acceleration measured at location (xᵢ, yᵢ); i=1,2,3

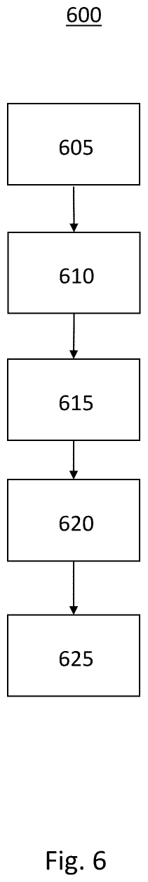

Turning now to FIG. 6, a flow diagram 600 of the method of one embodiment for accelerometer based tire normal force estimation is shown. In this exemplary embodiment, the method is operative to receive three acceleration measurements from three accelerometers mounted to the sprung mass of a vehicle 605. Each of the three acceleration measurements may include an x, y and z directional component, or may comprise vector information. Alternatively, the accelerometer information may include a single or multiple directional accelerations, such as z only, or x only.

The method is then operative to estimate vertical and horizontal force for at least one corner of the sprung mass of the vehicle 610. The method is then operative to estimate a normal tire force at a corner, in response to the estimated vertical and horizontal force for that corner 615. The method is then operative to generate a control signal indicating the estimated normal tire force for coupling to a controller for use in a control application such as traction control or the like 620. The method is then operative to control a control system of a vehicle in response to the control signal, such as a steering or braking system 625.

The detailed description and the drawings or figures are supportive and descriptive of the disclosure, but the scope of the disclosure is defined solely by the claims. While some of the best modes and other embodiments for carrying out the claimed teachings have been described in detail, various alternative designs and embodiments exist for practicing the disclosure defined in the appended claims.

What is claimed is:

1. A vehicle control system comprising:
a first accelerometer for measuring a first acceleration at a first point;
a second accelerometer for measuring a second acceleration at a second point;
a third accelerometer for measuring a third acceleration at a third point;
a processor for estimating a tire normal force in response to the first acceleration, the second acceleration and the third acceleration; and
a controller for controlling the vehicle in response to the tire normal force.

2. The vehicle control system of claim 1 wherein the controller is part of an adaptive cruise control system.

3. The vehicle control system of claim 1 wherein the controller is part of an antilock braking system.

4. The vehicle control system of claim 1 wherein the first accelerometer, the second accelerometer and the third accelerometer are mounted to a sprung mass on a vehicle.

5. The vehicle control system of claim 1 wherein the processor is further operative to estimate a sprung mass force at a corner of a vehicle and a sprung mass moment at a center of gravity of the vehicle and wherein the tire normal force is estimated in response to the sprung mass force and the sprung mass moment.

6. The vehicle control system of claim 1 wherein the estimation of the tire normal force involves estimating a first normal tire force at a first tire location and estimating a second normal tire force at a second tire location.

7. The vehicle control system of claim 1 wherein a first vertical component of the first acceleration and a second vertical component of the second acceleration are used to estimate the tire normal force at a first tire location.

8. A method for controlling a vehicle comprising:
Initiating a vehicle control system;
measuring a first acceleration at a first point, a second acceleration at a second point and a third acceleration at a third point, wherein the first point, the second point and the third point are locations on a sprung mass of the vehicle;
estimating a vertical acceleration at a fourth point in response to the first acceleration, the second acceleration, the third acceleration, wherein the fourth point is located on an unsprung mass of the vehicle;
generating a control signal in response to the vertical acceleration; and
controlling the vehicle control system in response to the control signal.

9. The method of claim 8 wherein the vehicle control system is an adaptive cruise control system.

10. The method of claim 8 wherein the vehicle control system is an antilock braking system.

11. The method of claim 8 wherein the first acceleration, the second acceleration and the third acceleration are measured by a first accelerometer, a second accelerometer, and a third accelerometer respectively.

12. The method of claim 8 comprising estimating a sprung mass force at a corner of a vehicle and a sprung mass moment at a center of gravity of the vehicle and wherein the vertical acceleration is estimated in response to the sprung mass force and the sprung mass moment.

13. The method of claim 8 wherein the estimation of the vertical is a first normal tire force at the fourth location.

14. The method of claim 8 wherein a first vertical component of the first acceleration and a second vertical component of the second acceleration are used to estimate the vertical force at the fourth location.

15. An apparatus comprising:
a first accelerometer for measuring a first acceleration at a first location on a sprung mass of a vehicle;
a second accelerometer for measuring a second acceleration at a second location on the sprung mass of the vehicle;
a third accelerometer for measuring a third acceleration at a third location on the sprung mass of the vehicle;
a processor for estimating a tire normal force of a tire no the vehicle in response to the first acceleration, the second acceleration and the third acceleration; and
a controller for controlling the vehicle in response to the tire normal force.

16. The apparatus of claim 15 wherein the processor is part of an adaptive cruise control system.

17. The apparatus of claim 15 wherein the processor is part of an antilock braking system.

18. The apparatus of claim 15 wherein the processor is further operative to estimate a sprung mass force at a corner of a vehicle and a sprung mass moment at a center of gravity of the vehicle and wherein the tire normal force is estimated in response to the sprung mass force and the sprung mass moment.

19. The system of claim 15 wherein the processor is further operative to estimate a vehicle traction coefficient in response to the tire normal force.

20. The system of claim 19 wherein the controller is operative to control a braking system to the tire in response to the normal tire force and a velocity of the vehicle.
